(19) United States
(12) Patent Application Publication
(10) Pub. No.: US 2006/0172907 A1
(43) Pub. Date: Aug. 3, 2006

(54) Microelectronic cleaning agent(s) and method(s) of fabricating semiconductor device(s) using the same

(75) Inventors: Sang-Yong Kim, Yongin-si (KR); Ji-Hoon Cha, Seoul (KR); Chang-Ki Hong, Seongnam-si (KR); Sang-Jun Choi, Seoul (KR); Woo-Gwan Shim, Yongin-si (KR); Kui-Jong Baek, Daejeon (KR); Sung-Bae Kim, Seoul (KR); Hyun-Tak Kim, Suwon-si (KR); Sang-Won Lee, Gongju-si (KR); Woong Han, Gongju-si (KR); Jung-Hun Lim, Daejeon (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/341,412

(22) Filed: Jan. 30, 2006

(30) Foreign Application Priority Data
Feb. 1, 2005 (KR) 10-2005-0009254

(51) Int. Cl. C11D 7/32

(52) U.S. Cl. 510/175

(57) ABSTRACT

According to an example embodiment of the present invention, the microelectronic cleaning agent may include a fluoride component, an acid component, a chelating agent, a surfactant and water. Example embodiments of the present invention provide a microelectronic cleaning agent which can selectively remove, for example, a high-k dielectric layer. The microelectronic cleaning agent includes from about 0.001 weight % to about 10 weight % of a fluoride component, from about 0.001 weight % to about 30 weight % of an acid component, from about 0.001 weight % to about 20 weight % of a chelating agent, from about 0.001 weight % to about 10 weight % of a surfactant, and water (H₂O). The water may comprise the remainder of the cleaning agent. According to another embodiment of the present invention, a method of fabricating a semiconductor device using the microelectronic cleaning agent is also provided.

### PRIORITY STATEMENT

This application claims priority under 35 U.S.C. §119 of Korean Patent Application No. 10-2005-0009254, filed on Feb. 01, 2005, in the Korean Intellectual Property Office (KIPO), the entire contents of which are incorporated herein by reference.

### BACKGROUND OF THE INVENTION

1. Field of the Invention

Example embodiments of the present invention relate to a composition of a surface treatment agent used, for example, for fabricating a semiconductor device. More particularly, according to example embodiments of the present invention, a microelectronic cleaning agent is provided (which may be used in processes, for example, of wet etching and/or cleaning an oxide layer) and a method of fabricating a semiconductor device using the same is provided.

2. Description of the Related Art

In a semiconductor device, an oxide layer may be used for a variety of components, for example, a gate dielectric layer and/or a capacitor dielectric layer. It may be advantageous to reduce or minimize current leakage from a gate dielectric layer and/or a capacitor dielectric layer. Also, it may be advantageous to maintain an adequate capacitance (C) in a gate dielectric layer and/or a capacitor dielectric layer. The capacitance (C) is inversely proportional to the thickness of the dielectric layer and is proportional to the surface area of the dielectric layer. That is, the thinner the dielectric layer, the greater the capacitance (C) per unit area.

In high integration density semiconductor devices, the gate dielectric layer and/or the capacitor dielectric layer may be small. However, when the surface area of the dielectric layer is reduced, the capacitance (C) is proportionally reduced. Accordingly, various methods of compensating for the reduction of the capacitance (C) have been researched. In order to increase the capacitance (C) per unit area, the thickness of the dielectric layer may be reduced. Silicon oxide may be used for forming the dielectric layer. However, with a thin silicon oxide gate dielectric layer and/or a thin silicon oxide capacitor dielectric layer, the current leakage increases inversely with the thickness of the silicon oxide gate dielectric or capacitor dielectric layer.

Accordingly, in order to solve the high current leakage problem (associated with thin silicon oxide gate and/or capacitor dielectric layers), a high-k dielectric layer having a permittivity higher than that of the silicon oxide layer may be used as the material for forming the dielectric layer. The high-k dielectric layer includes (but is not limited to) metal oxide layers such as a hafnium oxide layer (HfO) and a zirconium oxide layer (ZrO). Other suitable high-k dielectric layers may be used. A high-k dielectric layer has a capacitive equivalent thickness less than that of the silicon oxide layer (having the same thickness). That is, if a high-k dielectric layer is used, the capacitance (C) per unit area greater than that of the silicon oxide layer may be obtained at the same thickness. Accordingly, a high-k dielectric layer may be used for increasing the capacitance (C) per unit area without increasing the current leakage.

Moreover, semiconductor device(s) are typically subjected to processes of forming and partially removing an oxide layer, for example, such as a dielectric layer. Methods for removing an oxide layer may include (but are not limited to) a dry etching method and/or a wet etching method. A wet etching method may be performed by contact with an etching agent.

In a semiconductor device which includes a gate electrode, an active area, and a device isolation layer, the gate electrode may be formed of polysilicon, the active area may be formed of single crystal silicon, and the device isolation layer may be formed of a silicon oxide layer. One method of fabricating the semiconductor device may include, for example, forming the device isolation layer (for defining the active area on a semiconductor substrate), forming a high-k dielectric layer which covers an upper surface of the device isolation layer and the active area, and forming a gate electrode on the active area. Thereafter, the high-k dielectric layer may be selectively removed (except in the region of the high-k dielectric layer disposed between the gate electrode and the active area). If the high-k dielectric layer is over-etched, the device isolation layer may become etched and recessed. Also, if the high-k dielectric layer is imprecisely removed, the leakage current may increase due to metal contamination. Furthermore, during removal of the high-k dielectric layer, other etching may cause the surface treatment agent to come into contact with the semiconductor substrate.

### SUMMARY

Pursuant to an example embodiment of the present invention, a microelectronic cleaning agent comprising a fluoride component, an acid component, a chelating agent, a surfactant and water is provided.

According to an example embodiment of the present invention, a microelectronic cleaning agent which can selectively remove a high-k dielectric layer is provided.

Pursuant to another example embodiment of present invention, a method of fabricating a semiconductor device using the above-noted microelectronic cleaning agent is provided.

An example embodiment of a microelectronic cleaning agent of the present invention includes from about 0.001 weight % to about 10 weight % of a fluoride component (e.g., 0.01, 0.05, 0.1, 0.5, 1.2, 3, 4, 5, 6, 7, 8 or 9 weight %), from about 0.001 weight % to about 30 weight % of an acid component (e.g., 0.01, 0.05, 0.1, 0.5, 1, 2, 3, 4, 5, 6, 7, 8, 9, 10, 12, 14, 16, 18, 20, 22, 24, 26, 28, or 29 weight %), from about 0.001 weight % to about 20 weight % of a chelating agent (e.g., 0.01, 0.1, 0.5, 1.2, 3, 4, 5, 6, 7, 8, 9, 10, 11, . . . or 19 weight %), from about 0.001 weight % to about 10 weight % of surfactant (e.g., 0.01, 0.05, 0.1, 0.5, 1.2, 3, 4, 5, 6, 7, 8 or 9 weight %), and water (H₂O). Water may be provided in an amount to be the remainder of the microelectronic cleaning agent. Note that the weight % values are based on a total weight of the cleaning agent.

In several example embodiments of the present invention, the fluoride component may include (but is not limited to) HF, NH₄F, or a mixture thereof.

In other example embodiments of the present invention, the acid component may include (but is not limited to) at least one selected from the group consisting of HNO₃, HCl, HClO₄, H₃PO₄, H₂SO₄, H₅IO₆, and CH₃COOH.

In still other example embodiments of the present invention, the chelating agent may include (but is not limited to) at least one selected from the group consisting of monoethanolamine (C₂H₇NO), diethanolamine (C₄H₁₁NO₂), triethanolamine (C₆H₁₅NO₃), diethylenetriamine (C₄H₁₃N₃), methylamine (CH₃NH₂), ethylamine (C₂H₅NH₂), propyl (C₃H₇—NH₂), butyl (C₄H₉—NH₂), and pentyl (C₅H₁₁—NH₂). Other non-limiting examples of suitable chelating agents may include a ligand of aminecarboxylic acid such as diethylenetriaminepentaacetic acid (C₆H₁₆N₃O₂). Still other non-limiting examples of chelating agents may include at least one selected from the group of amino acid consisting of glycine (C₈H₉NO₃), alanine (C₃H₇NO₂), valine ((CH₃)₂CHCH(NH₂)COOH), leucine (C₆H₁₃NO₂), isoleucine (C₆H₁₃NO₂), serine (HOCH₂CH(NH₂)COOH), threonine (C₄H₉NO₃), tyrosine (C₉H₁₁NO₃), tryptophane (C₁₁H₁₂N2O2), aspartic acid (C₄H₇O₄N), glutamine (C₆O₃H₁₀N₂), aspartic acid (C₄H₇O₄N), lysine (H₂N(CH₂)₄(NH₂)COOH), arginine (C₆H₁₄N₄O₂), histidine (C₆H₉N₃O₂), cysteine (C₃H₇NO₂S), methionine (C₅H₁₁NO₂S), cystine (C₆H₁₂N₂O₄S₂), proline (lumino acid) (C₅H₉NO₂), sulfamine (C₆H₈N₂O₂S), and hydroxyproline (C₅H₉NO₃).

In other example embodiments of the present invention, non-limiting examples of surfactants include at least one polymer having ethylene oxide (—C—C—O—) and —OH groups. Non-limiting examples of the polymer include polymers of ethylene glycol (C₂H₆O₂), propylene glycol (C₃H₈O₂), diethylene glycol (C₄H₁₀O₃), triethylene glycol (C₆H₁₄O₄), dipropylene glycol (C₆H₁₄O₃), ethylene glycol methyl butyl ether (C₇H₁₆O₂), polyoxyethylene dodecyl ether (C₁₂H₂₅O(C₂H₄O)ₙH), polyoxyethylene oleyl ether (C₁₈H₃₇O(C₂H₄O)ₙH), polyoxyethylene cetyl ether (C₁₆H₃₃O(C₂H₄O)ₙH), polyoxyethylene stearyl ether (C₁₈H₃₅O(C₂H₄O)ₙH), polyoxyethylene octyl ether (C₈H₁₇O(C₂H₄O)ₙH), polyoxyethylene tridecyl ether (C₁₃H₃₇O(C₂H₄O)ₙH), polyoxyethylene dodecyl ester (C₁₂H₂₅COO(C₂H₄O)ₙH), polyoxyethylene oleyl ester (C₁₈H₃₇COO(C₂H₄O)ₙH), polyoxyethylene cetyl ester (C₁₆H₃₃COO(C₂H₄O)ₙH), polyoxyethylene stearyl ester (C₁₈H₃₅COO(C₂H₄O)ₙH), and polyoxyethylene octyl ester (C₈H1₇COO(C₂H₄O)ₙH), respectively. Note that n is an integer such that n≧1.

In other example embodiments of the present invention, the microelectronic cleaning agent includes 0.1 weight % to 1 weight % of fluoride, 0.001 weight % to 30 weight % of acid, 0.1 weight % to 1 weight % of a chelating agent, 0.1 weight % to 1 weight % of surfactant, and water (H₂O). Water may be provided in an amount to be the remainder of the microelectronic cleaning agent. The weight % values are based on a total weight of the cleaning agent.

According to another aspect of an example embodiment of the present invention, there is provided a method of fabricating a semiconductor device using one or more of the above-noted microelectronic cleaning agents. The method may include forming a dielectric layer on a semiconductor substrate, and forming a mask pattern on the semiconductor substrate and exposing the dielectric layer through the mask pattern to form exposed regions of the dielectric layer. Subsequently, the exposed dielectric layer may then be etched using a microelectronic cleaning agent. According to an example embodiment of the present invention, microelectronic cleaning agent may include from about 0.001 weight % to about 10 weight % of a fluoride component, from about 0.001 weight % to about 30 weight % of an acid component, from about 0.001 weight % to about 20 weight % of a chelating agent, from about 0.001 weight % to about 10 weight % of surfactant, and the remainder water (H₂O). Note that the weight % values are based on a total weight of the cleaning agent.

In several example embodiments of the present invention, the dielectric layer may be made of at least one high-k dielectric member selected from the group consisting of AlO, GdO, YbO, DyO, NbO, YO, HfO, HfO₂, HfSiO, HfAlO, HfSiON, ZrSiO, ZrAlO, ZrO, LaO, TaO, TiO, SrTiO, and BaSrTiO.

In other example embodiments of the present invention, the mask pattern may include a gate electrode. Also, according to another example embodiment of the present invention, the mask pattern may further include a hard mask pattern laminated on the gate electrode together with the gate electrode.

In still other example embodiments of the present invention, etching the exposed dielectric layer may be performed at a temperature from about 10° C. to about 80° C. (e.g., 20° C., 30° C., 40° C., 50° C., 60° C., and 70° C.).

In yet other example embodiments of the present invention, a method includes forming a dielectric layer on a semiconductor substrate, and forming a mask pattern on the semiconductor substrate and exposing the dielectric layer through the mask pattern to expose regions of the dielectric layer. Subsequently, the exposed dielectric layer may be etched using a microelectronic cleaning agent. A non-limiting example of a microelectronic cleaning agent according to the present invention, includes from about 0.1 weight % to about 1 weight % of a fluoride component, from about 0.001 weight % to about 30 weight % of an acid component, from about 0.1 weight % to about 1 weight % of a chelating agent, from about 0.1 weight % to about 1 weight % of surfactant, and the remainder water (H₂O). Note the various weight % values are based on a total weight of the cleaning agent.

### BRIEF DESCRIPTION OF THE DRAWINGS

Example embodiments of the present invention will be more clearly understood from the detailed description taken in conjunction with the accompanying drawings.

FIGS. 1-12 represent non-limiting examples, embodiments and/or intermediates of the present invention as disclosed herein.

FIG. 1 is a distribution diagram illustrating relative concentrations of activated species in a HF aqueous solution according to an example embodiment of the present invention;

FIGS. 2 and 3 illustrate a relationship between etching rate, selectivity and concentration of acid mixed into the HF aqueous solution according to example embodiment(s) of the present invention;

FIGS. 4 and 5 illustrate a relationship between the etching rate, selectivity and concentration of HF mixed into a HNO₃ aqueous solution according to example embodiment(s) of the present invention;

FIG. 6 illustrates a relationship between the etching rate, selectivity and process temperature according to example embodiment(s) of the present invention;

FIG. 7 illustrates a relationship between amount of chelating agent and etching rate according to example embodiment(s) of the present invention;

FIG. 8 illustrates a relationship between amount of surfactant and etching rate according to example embodiment(s) of the present invention;

FIG. 9 is an illustration of a composition of a microelectronic cleaning agent according to example embodiment(s) of the present invention; and

FIGS. 10 through 12 are cross-sectional views illustrating the intermediate products formed during formation of a semiconductor device according to an example embodiment method of fabricating a semiconductor device using example embodiment(s) of a microelectronic cleaning agent of the present invention.

### DETAILED DESCRIPTION OF EXAMPLE EMBODIMENTS OF THE INVENTION

Various example embodiments of the present invention will now be described more fully with reference to the accompanying drawings in which some example embodiments of the invention are shown. In the drawings, the thicknesses of layers and regions may be exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only the embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Also, the use of the words “compound,” “compounds,” or “compound(s),” refer to either a single compound or to a plurality of compounds. These words are used to denote one or more compounds but may also just indicate a single compound.

Now, in order to more specifically describe example embodiments of the present invention, various embodiments of the present invention will be described in detail with reference to the attached drawings. However, the present invention is not limited to the example embodiments, but may be embodied in various forms. In the figures, if a layer is formed on another layer or a substrate, it means that the layer is directly formed on another layer or a substrate, or that a third layer is interposed therebetween. In the following description, the same reference numerals denote the same elements.

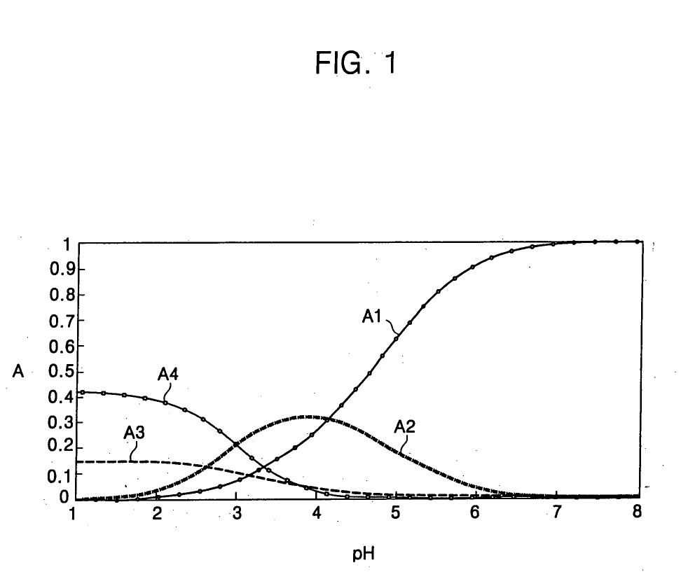

FIG. 1 is a distribution diagram illustrating relative concentrations of activated species in a HF aqueous solution according to an example embodiment of the present invention. The x-axis of FIG. 1 represents the pH of the HF aqueous solution. The y-axis A of FIG. 1 represents relative concentration of activated species.

Referring to FIG. 1, four (example embodiment) states of HF, namely, HF, H₂F₂, F⁻, and HF₂⁻ in the HF aqueous solution show varying concentration distributions plotted against pH at room temperature. Plot A1 is a distribution curve of F⁻. Plot A2 is a distribution curve of HF₂⁻. Plot A3 is a distribution curve of HF. Plot A4 is a distribution curve of H₂F₂. As shown, the relative concentrations of H₂F₂ (A4) and HF (A3) are higher in a pH range of about 1-2. That is, since acid dissociation does not readily occur at a low pH range, HF (A3) and H₂F₂ (A4) predominate. However, in a pH range of about 7-8, F⁻ (A1) predominates. HF₂⁻ (A2) predominates at a pH of about 4.

The main etching species of a silicon oxide layer is HF₂⁻ (A2). That is, the etching rate of the silicon oxide layer can be adjusted by changing the pH.

Furthermore, the etching rate of the silicon oxide layer may be changed according to a surface state of the silicon oxide layer. When the pH is about 4, SiOH predominates on the surface of the silicon oxide layer. If the pH is less than 4, a proton H⁺ is accepted and, thus, SiOH₂⁺ predominates. If the pH is greater than 4, a proton H⁺ is lost and, thus, SiO⁻ predominates. SiOH₂⁺ reacts about 1000 to about 1500 times as fast as does SiOH. SiO⁻ reacts the slowest. Provided the foregoing, the etching of the silicon oxide layer may be increased at a pH of about 4 (e.g., pH=3-4) and may be decreased at a pH where HF₂⁻ does not predominate. This may be accomplished, according to an example embodiment of the present invention, by adjusting the pH.

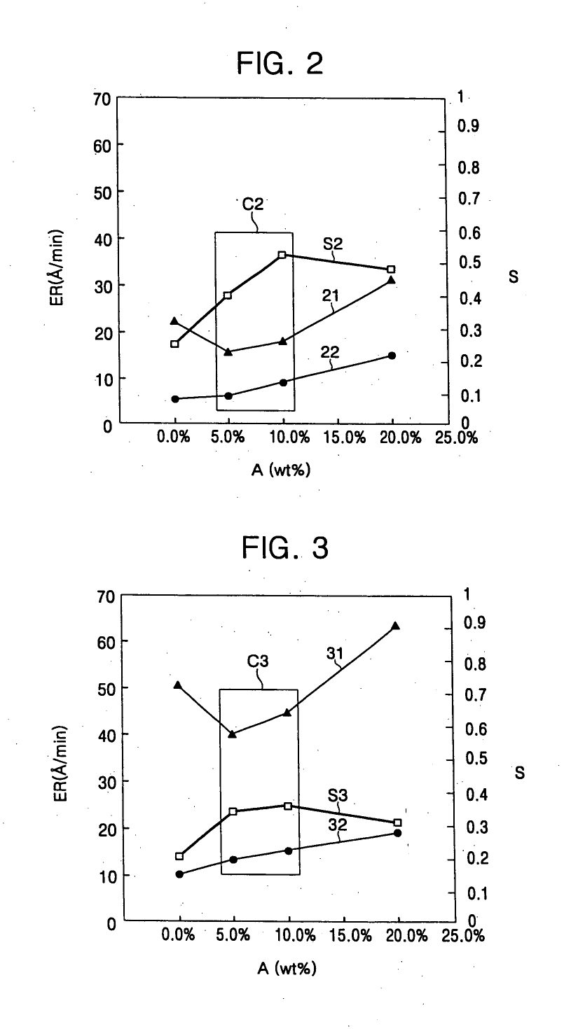

Referring to the example embodiment(s) of the present invention of FIGS. 2-3, FIGS. 2 and 3 illustrate a relationship between etching selectivity (as well as etching rate) and acid concentration mixed into the HF aqueous solution. Specifically, FIG. 2 illustrates the etching selectivity and the etching rates of HfO₂ and SiO₂ versus the amount of acid mixed into 0.5 weight % of the HF aqueous solution. The x-axis A of FIG. 2 represents the concentration of the mixed acid and its unit of scale is weight % based on a total weight of the aqueous solution. The y-axis ER of FIG. 2 represents the etching rate (in Å/min). An auxiliary axis S of FIG. 2 represents the selectively and is obtained by dividing the etching rate of HfO₂ by the etching rate of SiO₂. Also, FIG. 3 illustrates the etching selectivity and the etching rates of HfO₂ and SiO₂ versus the amount of acid mixed into 1.0 weight % of the HF aqueous solution. The x-axis A of FIG. 3 represents the concentration of the mixed acid and its unit of scale is weight % based on a total weight of the aqueous solution (e.g., the microelectronic cleaning agent). The y-axis ER of FIG. 3 represents the etching rate (in Å/min). The auxiliary axis S of FIG. 3 represents the selectively and is obtained by dividing the etching rate of HfO₂ by the etching rate of SiO₂. According to example embodiment(s) of the present invention, the acid added to the HF aqueous solution (in the example embodiments) of FIGS. 2 and 3 was HNO₃.

Referring to the example embodiment(s) of FIG. 2 of the present invention, plot 21 represents the etching rate of SiO₂ versus the amount of the acid mixed into 0.5 weight % of the HF aqueous solution. As the concentration of the mixed acid increases (e.g., HNO₃) from 0 to 5 weight %, the etching rate of SiO₂ decreases. Thereafter, as the concentration of the mixed acid increases from 5 to 20 weight %, the etching rate of SiO₂ increases. When the concentration of the mixed acid is 5 weight %, the etching rate of SiO₂ is about 15 Å/min, and, when the concentration of the mixed acid is 10 weight %, the etching rate of SiO₂ is about 17 Å/min. The weight % values are based on a total weight of the aqueous solution. Unless indicated otherwise, the weight % values below are based on a total weight of the aqueous solution (or the total weight of the microelectronic cleaning agent, as appropriate).

Plot 22 represents the etching rate of HfO₂ versus the amount of the acid mixed into 0.5 weight % of the HF aqueous solution. As the concentration of the mixed acid increases from 0 to 20 weight %, the etching rate of HfO₂ increases. When the concentration of the mixed acid is 5 weight %, the etching rate of HfO₂ is about 6 Å/min, and, when the concentration of the mixed acid is 10 weight %, the etching rate of HfO₂ is about 9 Å/min.

Plot S2 is a characteristic curve of the etching selectivity, e.g., a value obtained by dividing the etching rate of HfO₂ by the etching rate of SiO₂. When the concentration of the mixed acid is 5 weight %, the etching selectivity is 0.4, and, when the concentration of the mixed acid is 10 weight %, the etching selectivity is 0.53.

When the concentration of the mixed acid (e.g., HNO₃) increases to 20 weight %, both the etching rates of HfO₂ and SiO₂ increase, but the etching selectivity decreases. According to example embodiment(s) of the present invention, in order to increase the etching selectivity, it is possible to reduce the etching rate of SiO₂ and increase the etching rate of HfO₂ by choosing the appropriate acid concentration. For example, in box C2, as the concentration of the mixed acid increases, the etching selectivity linearly increases (as shown). Accordingly, when the concentration of the mixed acid is adjusted to within (or substantially within) the box C2, a desired etching selectivity may be readily obtained.

Referring to the example embodiment(s) of FIG. 3 of the present invention, a plot 31 represents the etching rate of SiO₂ versus the amount of the acid (e.g., HNO₃) mixed into 1.0 weight % of the HF aqueous solution. As the concentration of the mixed acid increases from 0 to 5 weight %, the etching rate of SiO₂ decreases. Thereafter, as the concentration of the mixed acid increases from 5 to 20 weight %, the etching rate of SiO₂ increases. When the concentration of the mixed acid is 5 weight %, the etching rate of SiO₂ is about 40 Å/min, and, when the concentration of the mixed acid is 10 weight %, the etching rate of SiO₂ is about 45 Å/min.

Plot 32 represents the etching rate of HfO₂ versus the amount of the acid (e.g., HNO₃) mixed into 1.0 weight % of the HF aqueous solution. As the concentration of the mixed acid (e.g., HNO₃) increases from 0 to 20 weight %, the etching rate of HfO₂ increases. When the concentration of the mixed acid is 5 weight %, the etching rate of HfO2 is about 13 Å/min, and, when the concentration of the mixed acid is 10 weight %, the etching rate of HfO₂ is about 16 Å/min.

Plot S3 is a characteristic curve of the etching selectivity. That is, a value obtained by dividing the etching rate of HfO₂ by the etching rate of SiO₂. When the concentration of the mixed acid is 5 weight %, the etching selectivity is 0.33, and, when the concentration of the mixed acid is 10 weight %, the etching selectivity is 0.36.

When the concentration of the mixed acid increases to 20 weight %, both the etching rates of HfO₂ and SiO₂ increase, but the etching selectivity decreases. According to an example embodiment of the present invention, in order to increase the etching selectivity, it is possible to reduce the etching rate of SiO₂ and increase the etching rate of HfO₂ by choosing the appropriate acid concentration. For example, in box C3, if the concentration of the mixed acid increases, the etching selectivity linearly increases. Accordingly, when the concentration of the mixed acid is adjusted to within (or substantially within) the boundaries of box C3, a desired etching selectivity may be readily obtained.

Referring to example embodiments of FIGS. 1, 2, and 3 of the present invention, as the concentration of the mixed acid increases, the etching rate of HfO₂ increases. Note that as the concentration of the mixed acid increases, the pH of the HF aqueous solution decreases. As shown in FIG. 1, the HF aqueous solution has higher relative concentrations of H₂F₂ (A4) and HF (A3) in a low pH range. That is, in the lower pH range, acid dissociation does not readily occur and, thus, HF and/or H₂F₂ predominate. Accordingly, the main etching species which influences the etching rate of HfO₂ is HF and/or H₂F₂.

Furthermore, according to an example embodiment of the present invention, when the concentration of the mixed acid is increased, at first, the etching rate of SiO₂ decreases followed by an increased etching rate of SiO₂ as the acid concentration is further increased. See plots 21 and 31 in the example embodiment(s) of FIGS. 2-3 of the present invention. This etching behavior results from the surface state of the silicon oxide layer and the concentration of HF₂⁻ (A2).

As can be seen from the example embodiment(s) of FIGS. 1, 2, and 3 of the present invention, in order to increase the etching selectivity, the pH should be adjusted so that the etching rate of SiO₂ may be reduced.

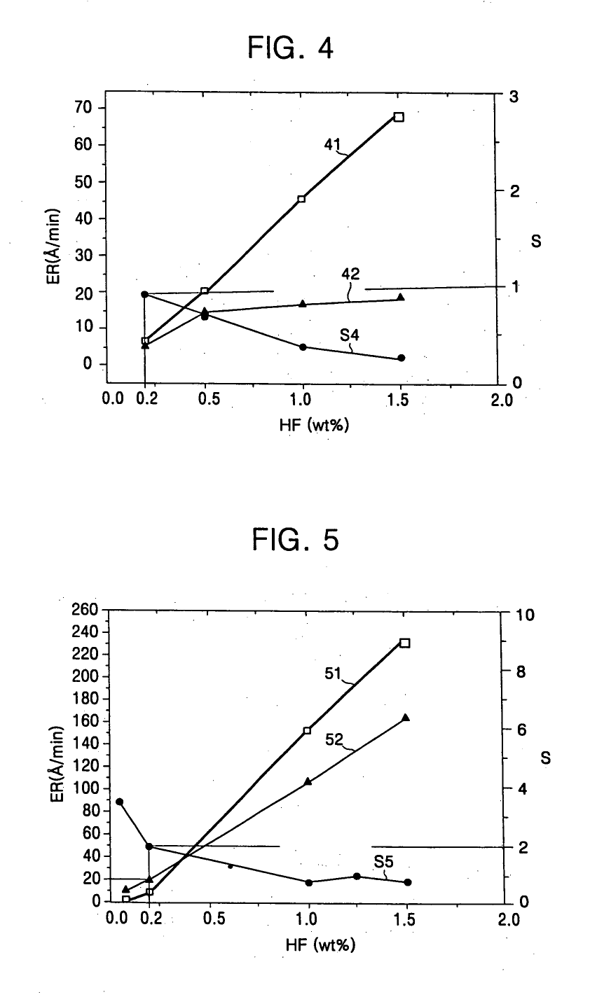

FIGS. 4 and 5 illustrate a relationship between the etching selectivity and a concentration of HF mixed into a HNO₃ aqueous solution according to example embodiments of the present invention. Specifically, the example embodiment(s) of FIG. 4 illustrate the etching selectivity and the etching rates of HfO₂ and SiO₂ versus the concentration of HF mixed into 10 weight % of the HNO₃ aqueous solution at room temperature. The x-axis of FIG. 4 represents the concentration (in weight %) of the HF mixed into HNO₃. The y-axis ER of FIG. 4 represents the etching rate (in Å/min). The auxiliary y-axis S of FIG. 4 represents the selectively and is obtained by dividing the etching rate of HfO₂ by the etching rate of SiO₂. Referring to FIG. 4, plot 41 represents the etching rate of SiO₂. As the concentration of the mixed HF increases from 0.1 to 1.5 weight %, the etching rate of SiO₂ increases.

Plot 42 represents the etching rate of HfO₂. When the concentration of the mixed HF increases from 0.1 to 1.5 weight %, the etching rate of HfO₂ increases. However, the plot 42 shows that the etching rate of HfO₂ has a slope smaller than that of the plot 41 which reflects the etching rate of SiO₂. That is, as the concentration of HF mixed into 10 weight % of the HNO₃ aqueous solution increases, the etching rate of SiO₂ rapidly increases, but the etching rate of HfO₂ gradually increases.

Plot S4 is a plot of the etching selectivity, e.g., a value obtained by dividing the etching rate of HfO₂ by the etching rate of SiO₂. As can be seen from plot 41 and plot 42, as the concentration of HF mixed into 10 weight % of the HNO₃ aqueous solution increases, the etching selectivity decreases. When the concentration of the mixed HF is 0.2 weight %, the etching selectivity is 1, and, when the concentration of the mixed HF is 1.0 weight %, the etching selectivity is 0.4.

Also, the example embodiment(s) of FIG. 5 illustrate the etching selectivity and the etching rates of HfO₂ and SiO₂ versus the concentration of HF mixed into 10 weight % of the HNO₃ aqueous solution at a temperature of 50° C. The x-axis of FIG. 5 represents the concentration (in weight %) of the HF mixed into HNO₃. The y-axis ER of FIG. 5 represents the etching rate (in Å/min). The auxiliary y-axis S of FIG. 5 represents the selectively and is obtained by dividing the etching rate of HfO₂ by the etching rate of SiO₂.

Referring to FIG. 5, plot 51 represents the etching rate of SiO₂ versus the concentration of HF mixed into 10 weight % of the HNO₃ aqueous solution. As the concentration of the mixed HF increases from 0.1 to 1.5 weight %, the etching rate of SiO₂ increases.

Plot 52 represents the etching rate of HfO₂ versus the concentration of HF mixed into 10 weight % of the HNO₃ aqueous solution. As the concentration of the mixed HF increases from 0.1 to 1.5 weight %, thⁱe etching rate of HfO₂ increases. However, plot 52 reflects the etching rate of HfO₂ which has a slope smaller than that of plot 51 which reflects the etching rate of SiO₂. That is, as the concentration of HF mixed into 10 weight % of HNO₃ aqueous solution increases, the etching rate of SiO₂ rapidly increases, but the etching rate of HfO₂ gradually increases.

Plot S5 is a plot of the etching selectivity, e.g., a value obtained by dividing the etching rate of HfO₂ by the etching rate of SiO₂. As can be seen from the plot 51 and plot 52, as the concentration of HF mixed into 10 weight % of the HNO₃ aqueous solution increases, the etching selectivity decreases. When the concentration of the mixed HF is 0.2 weight %, the etching selectivity is 2, and, when the concentration of the mixed HF is 1.0 weight %, the etching selectivity is 0.35.

Referring to the example embodiments of FIGS. 4 and 5 of the present invention, as the concentration of HF mixed into 10 weight % of HNO₃ aqueous solution decreases, the etching selectivity increases. Conversely stated, as the concentration of HF mixed into 10 weight % of HNO₃ aqueous solution increases, the etching selectivity decreases. These results indicate that at a low concentration of mixed HF in the HNO₃ aqueous solution, the etching rates of both HfO₂ and of SiO₂ are low. At a low etching rate, the time required for etching SiO₂ or HfO₂ is correspondingly increased. Accordingly, under various example embodiment(s) of the present invention, the concentration of HF mixed into HNO₃ may be selected so that the etching selectivity is maximized without sacrificing the etching rate. Stated alternatively, selecting the highest selectivity (for example, at the highest corresponding etching rate for HfO₂₎ and selecting a corresponding concentration of mixed HF will yield more efficient etching of HfO₂ versus etching of SiO₂.

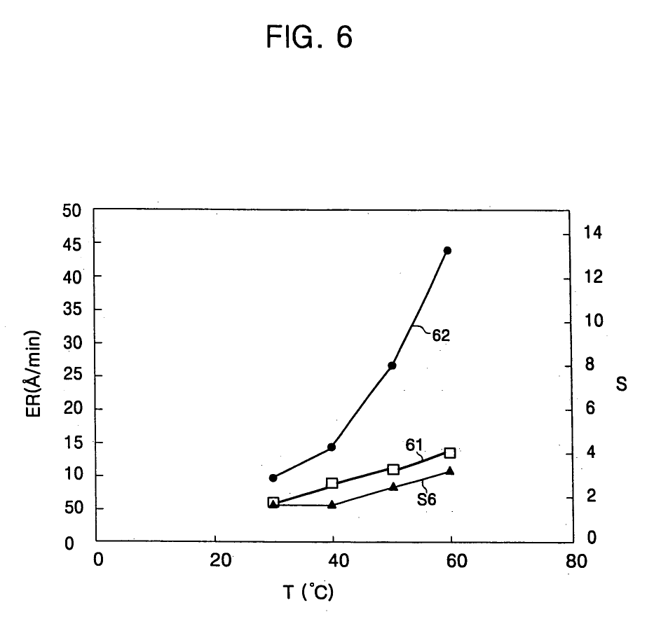

FIG. 6 illustrates a relationship between etching selectivity and process temperature according to example embodiment(s) of the present invention. Specifically, the example embodiment(s) of FIG. 6 of the present invention illustrate the etching selectivity and the etching rates of HfO₂ and SiO₂ versus temperature change of an aqueous solution containing 0.2 weight % of HF and 5 weight % of HNO₃. The x-axis T of FIG. 6 represents the process temperature (in ° C.). The y-axis ER of FIG. 6 represents the etching rate (in Å/min). The auxiliary y-axis S of FIG. 6 represents the etching selectivity versus temperature obtained by dividing the etching rate of HfO₂ by the etching rate of SiO₂.

Referring to FIG. 6, plot 61 represents the etching rate of SiO₂ versus the process temperature. As the process temperature increases from 30° C. to 60° C., the etching rate of SiO₂ gradually increases.

Plot 62 represents the etching rate of HfO₂ versus the process temperature. As the process temperature increases from 30° C. to 60° C., the etching rate of HfO₂ rapidly increases.

Plot S6 is a plot of the etching selectivity, e.g., a value obtained by dividing the etching rate of HfO₂ by the etching rate of SiO₂. As can be seen from the plot S6, as the process temperature increases, the etching selectivity increases. By increasing the process temperature, both the etching selectivity and the etching rate may be increased.

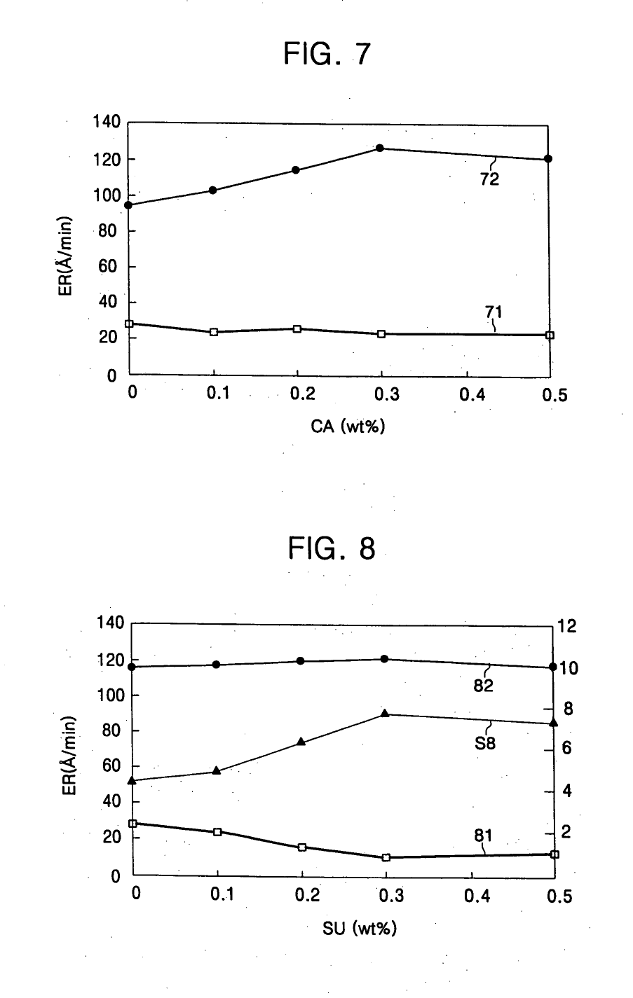

FIG. 7 illustrates a relationship between addition of a chelating agent and the etching rate according to example embodiment(s) of the present invention. Specifically, FIG. 7 illustrates the etching rates of HfO₂ and SiO₂ versus the amount of the chelating agent (in wt %) added to an aqueous solution containing 0.2 weight % of HF and 5 weight % of HNO₃. Further, the process temperature for the data of the example embodiment(s) of FIG. 7 was 60° C. The x-axis CA of FIG. 7 represents the concentration of the chelating agent (in wt %), in this example, monoethanolamine (C₂H₇NO). The y-axis ER of FIG. 7 represents the etching rate (in Å/min).

Referring to FIG. 7, plot 71 represents the etching rate of SiO₂ versus the amount of chelating agent added. As depicted by plot 71, although the concentration of the chelating agent increases from 0.1 weight % to 0.5 weight %, the etching rate of SiO₂ remains substantially unchanged.

Plot 72 represents the etching rate of HfO₂ versus the amount of chelating agent added. As depicted by plot 72, as the concentration of the chelating agent increases from 0.1 weight % to 0.5 weight %, the etching rate of HfO₂ also increases.

As shown, the chelating agent increases the etching rate of the HfO₂ while hardly influencing the etching rate of SiO₂. That is, by adjusting the concentration of the chelating agent, the etching selectivity may be increased together with increasing the etching rate of HfO₂.

FIG. 8 illustrates a relationship between addition of surfactant and the etching selectivity according to example embodiment(s) of the present invention. Specifically, FIG. 8 illustrates the etching selectivity and the etching rates of HfO₂ and SiO₂ versus the amount of surfactant added to an aqueous solution containing 0.2 weight % of HF, 5 weight % of HNO₃, and chelating agent. In this example, the surfactant was ethylene glycol (C₂H₆O₂) and the chelating agent was monoethanolamine (C₂H₇NO). Further, the process temperature for the date of example embodiments of FIG. 8 was 60° C. The x-axis SU of FIG. 8 represents the concentration of the surfactant (in weight % based on a total weight of the aqueous solution). The y-axis ER of FIG. 8 represents the etching rate (in Å/min). The auxiliary y-axis S of FIG. 8 represents the etching selectivity and is obtained by dividing the etching rate of HfO₂ by the etching rate of SiO₂.

Referring to FIG. 8, plot 81 represents the etching rate of SiO₂ versus the amount of the surfactant added. As the concentration of the surfactant increases from 0.1 weight % to 0.5 weight %, the etching rate of SiO₂ decreases.

Plot 82 represents the etching rate of HfO₂ versus the amount of the surfactant added. While the concentration of the surfactant increases from 0.1 weight % to 0.5 weight %, the etching rate of HfO₂ is hardly changed.

Plot S8 represents the etching selectivity, e.g., a value obtained by dividing the etching rate of HfO₂ by the etching rate of SiO₂. As can be seen from the plot 81 and plot 82, when the concentration of the surfactant increases, the etching selectivity increases. As shown, addition of the surfactant hardly influences the etching rate of the HfO₂, but decreases the etching rate of SiO₂. That is, by adjusting the concentration of the surfactant, the etching selectivity may be increased while maintaining the etching rate of HfO₂.

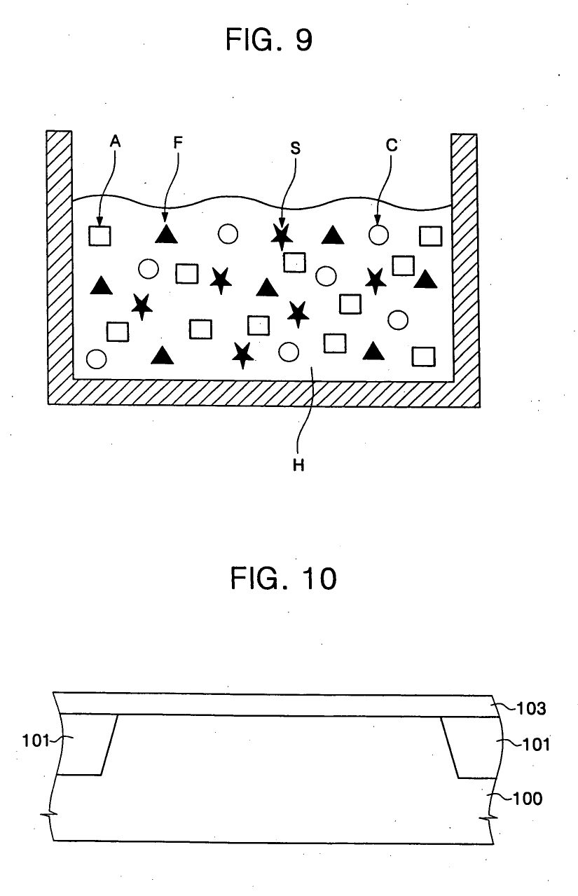

FIG. 9 illustrates a composition of a microelectronic cleaning agent according to example embodiment(s) of the present invention, wherein F=a fluoride component F, A=an acid component A, C=chelating agent C, S=surfactant S and H=water (H₂O) H.

Referring to FIG. 9, the microelectronic cleaning agent includes from about 0.001 weight % to about 10 weight % of a fluoride component F, from about 0.001 weight % to about 30 weight % of an acid component A, from about 0.001 weight % to about 20 weight % of a chelating agent C, from about 0.001 weight % to about 10 weight % of surfactant S, and water (H₂O) H. According to example embodiment(s) of the present invention, the water may be provided in an amount to be the remainder of the microelectronic cleaning agent.

The fluoride component F may etch an oxide layer, for example, a metal oxide layer and a silicon oxide layer. The fluoride component F may include (but is not limited to) HF, NH₄F, or mixture(s) thereof. Other suitable fluoride component(s) may be used.

The acid component A may increase the etching selectivity between the metal oxide layer and the silicon oxide layer. The acid component A may include (but is not limited to) at least one selected from the group consisting of HNO₃, HCl, HClO₄, H₃PO₄, H₂SO₄, H₅IO₆, and CH₃COOH. Other suitable acid component(s) may be used.

The chelating agent (C) may increase the etching rate of the metal oxide layer and may hardly influence the etching rate of the silicon oxide layer. That is, by adjusting the concentration of the chelating agent C, both the etching rate of the metal oxide layer and the etching selectivity may be increased. The chelating agent (C) may include (but is not limited to) at least one amine selected from the group consisting of monoethanolamine (C₂H₇NO), diethanolamine (C₄H₁₁NO₂), triethanolamine (C₆H₁₅NO₃), diethylenetriamine (C₄H₁₃N₃), methylamine (CH₃NH₂), ethylamine (C₂H₅NH₂), propyl amine (C3H₇—NH₂), butyl amine (C₄H₉—NH₂), and pentyl amine (C₅H₁₁—NH₂). Also, the chelating agent (C) may include (but is not limited to) a ligand of aminecarboxylic acid such as diethylenetriaminepentaacetic acid (C₆H₁₆N₃O₂). In addition, the chelating agent (C) may include at least one amino acid selected from the group consisting of glycine (C₈H₉NO₃), alanine (C₃H₇NO₂), valine ((CH₃)₂CHCH(NH₂)COOH), leucine (C₆H₁₃NO₂), isoleucine (C₆H₁₃NO₂), serine (HOCH₂CH(NH₂)COOH), threonine (C₄H₉NO₃), tyrosine (C₉H₁₁NO₃), tryptophane (C₁₁H₁₂N₂O₂), aspartic acid (C₄H₇O₄N), glutamine (C₆O₃H₁₀N₂), aspartic acid (C₄H₇O₄N), lysine (H₂N(CH₂)₄(NH₂)COOH), arginine (C₆H₁₄N₄O₂), histidine (C₆H₉N₃O₂), cysteine (C₃H₇NO₂S), methionine (C₅H₁₁NO₂S), cystine (C₆H₁₂N₂O₄S₂), proline (lumino acid) (C₅H₉NO₂), sulfamine (C₆H₈N₂O₂S), and hydroxyproline (C₅H₉NO₃). Other suitable chelating agent(s) may be used.

The surfactant S may hardly influence the etching rate of the metal oxide layer, but may decrease the etching rate of the silicon oxide layer. That is, by adjusting the concentration of the surfactant S, the etching selectivity may be increased while maintaining the etching rate of the metal oxide layer. The surfactant S may include (but is not limited to) at least one member selected from the group consisting of a polymer having ethylene oxide (—C—C—O—) and —OH group. The polymer may contain ethylene glycol (C₂H₆O₂), propylene glycol (C₃H₈O₂), diethylene glycol (C₄H₁₀O₃), triethylene glycol (C₆H₁₄O₄), dipropylene glycol (C₆H₁₄O₃), ethylene glycol methyl butyl ether (C₇H₁₆O₂), polyoxyethylene dodecyl ether (C₁₂H₂₅O(C₂H₄O)ₙH), polyoxyethylene oleyl ether (C₁₈H₃₇O(C₂H₄O)ₙH), polyoxyethylene cetyl ether (C₁₆H₃₃O(C₂H₄O)ₙH), polyoxyethylene stearyl ether (C₁₈H₃₅O(C₂H₄O)ₙH), polyoxyethylene octyl ether (C₈H₁₇O(C₂H₄O)ₙH), polyoxyethylene tridecyl ether (C₁₃H₃₇O(C₂H₄O)ₙH), polyoxyethylene dodecyl ester (C₁₂H₂₅COO(C₂H₄O)ₙH), polyoxyethylene oleyl ester (C₁₈H₃₇COO(C₂H₄O)ₙH), polyoxyethylene cetyl ester (C₁₆H₃₃COO(C₂H₄O)ₙH), polyoxyethylene stearyl ester (C₁₈H₃₅COO(C₂H₄O)ₙH), and polyoxyethylene octyl ester (C₈H₁₇COO(C₂H₄O)ₙH). Other suitable surfactant(s) may be used.

In another example embodiment of the present invention, the microelectronic cleaning agent includes from about 0.1 weight % to about 1 weight % of a fluoride component F, from about 0.001 weight % to about 30 weight % of an acid component A, from about 0.1 weight % to about 1 weight % of a chelating agent C, from about 0.1 weight % to about 1 weight % of surfactant S, and water (H₂O) H based on a total weight of the cleaning agent. According to example embodiment(s) of the present invention, the water may be provided in an amount to be the remainder of the microelectronic cleaning agent.

As described with reference to example embodiments of FIGS. 1 through 8, the microelectronic cleaning agent according to example embodiments of the present invention may have a higher etching selectivity (between the metal oxide layer and the silicon oxide layer higher) than that of a conventional cleaning agent. That is, if the aforementioned microelectronic cleaning agent of example embodiment(s) of the present invention are/may be used, the metal oxide layer may be etched at an etching rate higher than that of the silicon oxide layer.

Now, an example embodiment method of fabricating a microelectronic cleaning agent according to the present invention is described. Example embodiments include preparing a solution containing the fluoride component, the acid component, the chelating agent, and the surfactant mixed into an amount of water (H₂O).

According to an example embodiment of the present invention, the water (H₂O) is deionized water or purified water (H₂O) such as distilled water. The fluoride component, the acid component, the chelating agent, and the surfactant may be mixed into the water (H₂O) in descending concentration order, e.g., the component of highest concentration may be added first and the component of the lowest concentration may be added last. The mixing process may be performed at about room temperature (e.g., about 20-25° C.).

Example embodiment(s) of FIGS. 10 through 12 represent cross-sectional views illustrating fabricating a semiconductor device using the microelectronic cleaning agent in accordance with example embodiments of the present invention.

Referring to the example embodiment(s) of FIG. 10 of the present invention, a device isolation layer 101 for defining an active area may be formed on a desired area of a semiconductor substrate 100. The semiconductor substrate 100 may be a silicon wafer or a silicon on insulator (SOI) substrate. The device isolation layer 101 may be formed of a silicon oxide layer using, for example, a high density plasma chemical vapor deposition (HDPCVD) method. Other suitable device isolation layer forming processes may be used.

According to the example embodiment(s) of FIG. 10 of the present invention, a dielectric layer 103 may be formed on the semiconductor substrate 100 having the device isolation layer 101. The dielectric layer 103 may be formed of a silicon oxide layer or a high-k dielectric layer. The high-k dielectric layer may be formed of a member selected from the group consisting of AlO, GdO, YbO, DyO, NbO, YO, HfO, HfSiO, HfAlO, HfSiON, ZrSiO, ZrAlO, ZrO, LaO, TaO, TiO, SrTiO, and BaSrTiO. Other suitable high-k dielectric layer material(s) may be used. The high-k dielectric layer may be formed using, for example, a physical vapor deposition (PVD) method, a chemical vapor deposition (CVD) method, or an atomic layer deposition (ALD) method. Other suitable high-k dielectric layer forming processes may be used.

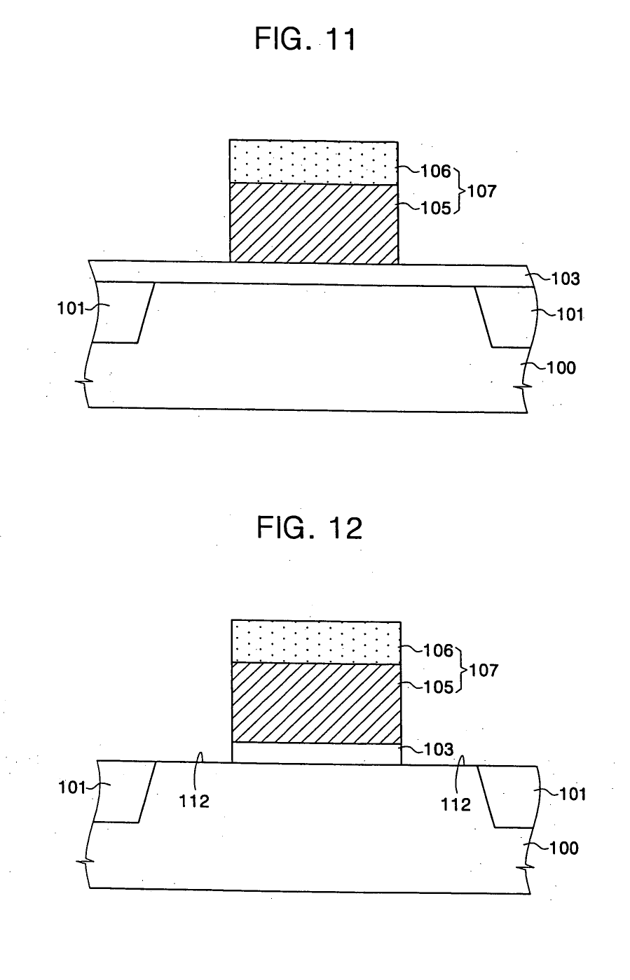

Referring to the example embodiment(s) of FIG. 11 of the present invention, a mask pattern 107 may be formed on the semiconductor substrate 100 having the dielectric layer 103. The mask pattern 107 may include a gate electrode 105 and a hard mask pattern 106 laminated in sequence. Also, the mask pattern 107 may include only the gate electrode 105. Specifically, a gate conductive layer (of the gate electrode) and a hard mask layer may be formed on the semiconductor substrate 100 coated with the dielectric layer 103. The gate conductive layer may include (but is not limited to), for example, a polysilicon layer and a tungsten silicide layer laminated in sequence. Other suitable gate conductive layer material(s) may be used. The hard mask layer may be formed of a silicon nitride layer or a silicon oxynitride layer. Other suitable hard mask layer materials may be used. The hard mask layer and the gate conductive layer may be successively patterned to form the hard mask 106 on the gate electrode 105. As a result, an upper surface of the dielectric layer 103 may be divided into an uncovered (e.g., exposed) area and an area covered by the mask pattern 107.

Referring to the example embodiment(s) of FIG. 12 of the present invention, the uncovered/exposed portions of the dielectric layer 103 may be brought into contact with a microelectronic cleaning agent for etching with the same. An example embodiment of the microelectronic cleaning agent according to the present invention includes from about 0.001 weight % to about 10 weight % of a fluoride component F, from about 0.001 weight % to about 30 weight % of an acid component A, from about 0.001 weight % to about 20 weight % of a chelating agent C, from about 0.001 weight % to about 10 weight % of surfactant S, and water (H₂O) H, based on a total weight of the microelectronic cleaning agent. The amount of water (H₂O) H may be the remainder of the microelectronic cleaning agent.

In another example embodiment of the present invention, the microelectronic cleaning agent may include from about 0.1 weight % to about 1 weight % of a fluoride component F, from about 0.001 weight % to about 30 weight % of an acid component A, from about 0.1 weight % to about 1 weight % of a chelating agent C, from about 0.1 weight % to about 1 weight % of surfactant S, and water (H₂O) H, based on a total weight of the microelectronic cleaning agent. The amount of water (H₂O) H may be the remainder of the microelectronic cleaning agent.

The process of bringing the exposed dielectric layer 103 into contact with the microelectronic cleaning agent may be performed using a shower method or a dipping method. Other suitable processes for accomplishing the same may be used. Also, the process of etching the exposed dielectric layer 103 may be performed at a temperature from about 10° C. to about 80° C. (e.g., 15, 20, 25, 30, 35, 40, 45, 50, 55, 60, 65, 70, or 75° C.). The microelectronic cleaning agent may react more rapidly at higher temperatures. Thus, for example, the exposed dielectric layer 103 is more rapidly etched at a temperature of 60° C., compared with etching at room temperature (e.g., about 25° C.).

According to the example embodiment(s) of FIG. 12 of the present invention, due to etching, the dielectric layer 103 covered by the mask pattern may remain intact while the uncovered/exposed dielectric layer may be etched away by the microelectronic cleaning solution to expose surface 112. In the uncovered/exposed areas in which the dielectric layer 103 is etched away and removed, a surface 112 of the active area and the device isolation layer 101 may be exposed. The remaining dielectric layer 103 under the gate electrode 105 may serve as a gate dielectric layer. The dielectric layer 103 may be formed of the high-k dielectric material containing a metal material. If the high-k dielectric layer is imprecisely etched, the metal oxide layer may remain on surface 112 of the active area and the device isolation layer 101. An imprecisely etched remaining metal oxide layer may cause defects resulting in an increase of the leakage current and/or the contact resistance. To avoid such problems, a microelectronic cleaning agent according to example embodiment(s) of the present invention having an improved etching rate for the high-k dielectric layer (such as the metal oxide layer) may be used. In addition, the microelectronic cleaning agent according to example embodiment(s) of the present invention may have a high etching selectivity favoring etching the high-k dielectric layer over etching the silicon oxide layer. That is, the microelectronic cleaning agent may more rapidly etch the high-k dielectric layer than the silicon oxide layer. Accordingly, the exposed dielectric layer 103 may be more perfectly removed and unwanted etching of the device isolation layer 101 may be avoided and/or minimized. Thus, undesirably recessing the device isolation layer 101 may be prevented.

By these (and others) example embodiment(s) of the present invention, a semiconductor device may be fabricated using a general fabricating process such as formation of source/drain electrode(s).

As mentioned above, according to example embodiment(s) of the present invention, a microelectronic cleaning agent containing a fluoride component, an acid component, a chelating agent, a surfactant, and water (H₂O) is provided. According to example embodiment(s) of the present invention, the microelectronic cleaning agent may have a higher etching selectivity for a high-k dielectric layer over that of a silicon oxide layer. Thus, such a microelectronic cleaning agent may be used in a process of forming a high-k dielectric layer, for example, a gate dielectric layer and/or a capacitor dielectric layer of a semiconductor device.

Although the example embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A microelectronic cleaning agent comprising a fluoride component, an acid component, a chelating agent, a surfactant and water.

2. The microelectronic cleaning agent of claim 1 comprising from about 0.001 weight % to about 10 weight % of the fluoride component, from about 0.001 weight % to about 30 weight % of the acid component, from about 0.001 weight % to about 20 weight % of the chelating agent, from about 0.001 weight % to about 10 weight % of the surfactant, and water (H₂O), based on a total weight of the microelectronic cleaning agent.

3. The microelectronic cleaning agent according to claim 1, wherein the fluoride component includes HF, NH₄F, or a mixture thereof.

4. The microelectronic cleaning agent according to claim 1, wherein the acid component includes at least one member selected from the group consisting of HNO₃, HCl, HClO₄, H₃PO₄, H₂SO₄, H₅IO₆, and CH₃COOH.

5. The microelectronic cleaning agent of claim 1, wherein the chelating agent includes at least one amine.

6. The microelectronic cleaning agent according to claim 1, wherein the chelating agent includes at least one amine selected from the group consisting of monoethanolamine (C₂H₇NO), diethanolamine (C₄H₁₁NO₂), triethanolamine (C₆H₁₅NO₃), diethylenetriamine (C₄H₁₃N₃), methylamine (CH₃NH₂), ethylamine (C₂H₅NH₂), propyl (C₃H₇—NH₂), butyl (C₄H₉—NH₂), and pentyl (C₅H₁₁—NH₂).

7. The microelectronic cleaning agent of claim 1, wherein the chelating agent includes a ligand.

8. The microelectronic cleaning agent according to claim 7, wherein the ligand is an aminecarboxylic acid.

9. The microelectronic cleaning agent according to claim 8, wherein the aminecarboxylic acid is diethylenetriaminepentaacetic acid (C₆H₁₆N₃O₂).

10. The microelectronic cleaning agent of claim 1, wherein the chelating agent includes at least one amino acid.

11. The microelectronic cleaning agent according to claim 10, wherein the at least one amino acid is selected from the group consisting of glycine (C₈H₉NO₃), alanine (C₃H₇NO₂), valine ((CH₃)₂CHCH(NH₂)COOH), leucine (C₆H₁₃NO₂), isoleucine (C₆H₁₃NO₂), serine (HOCH₂CH(NH₂)COOH), threonine (C₄H₉NO₃), tyrosine (C₉H₁₁NO₃), tryptophane (C₁₁H₁₂N₂O₂), aspartic acid (C₄H₇O₄N), glutamine (C₆O₃H₁₀N₂), aspartic acid (C₄H₇O₄N), lysine (H₂N(CH₂)₄(NH₂)COOH), arginine (C₆H₁₄N₄O₂), histidine (C₆H₉N₃O₂), cysteine (C₃H₇NO₂S), methionine (C₅H₁₁NO₂S), cystine (C₆H₁₂N₂O₄S₂), proline (lumino acid) (C₅H₉NO₂), sulfamine (C₆H₈N₂O₂S), and hydroxyproline (C₅H₉NO₃).

12. The microelectronic cleaning agent of claim 1, wherein the surfactant includes at least one polymer.

13. The microelectronic cleaning agent according to claim 12, wherein the at least one polymer has at least an ethylene oxide (—C—C—O—) group and an —OH group.

14. The microelectronic cleaning agent according to claim 12, wherein the at least one polymer is selected from the group consisting of ethylene glycol (C₂H₆O₂), propylene glycol (C₃H₈O₂), diethylene glycol (C₄H₁₀O₃), triethylene glycol (C₆H₁₄O₄), dipropylene glycol (C₆H₁₄O₃), ethylene glycol methyl butyl ether (C₇H₁₆O₂), polyoxyethylene dodecyl ether (C₁₂H₂₅O(C₂H₄O)ₙH), polyoxyethylene oleyl ether (C₁₈H₃₇O(C₂H₄O)ₙH), polyoxyethylene cetyl ether (C₁₆H₃₃O(C₂H₄O)ₙH), polyoxyethylene stearyl ether (C₁₈H₃₅O(C₂H₄O)ₙH), polyoxyethylene octyl ether (C₈H₁₇O(C₂H₄O)ₙH), polyoxyethylene tridecyl ether (C₁₃H₃₇O(C₂H₄O)ₙH), polyoxyethylene dodecyl ester (C₁₂H₂₅COO(C₂H₄O)ₙH), polyoxyethylene oleyl ester (C₁₈H₃₇COO(C₂H₄O)ₙH), polyoxyethylene cetyl ester (C₁₆H₃₃COO(C₂H₄O)ₙH), polyoxyethylene stearyl ester (C₁₈H₃₅COO(C₂H₄O)ₙH), and polyoxyethylene octyl ester (C₈H₁₇COO(C₂H₄O)ₙH),
wherein n is an integer so that n≧1.

15. The microelectronic cleaning agent of claim 1 comprising from about 0.1 weight % to about 1 weight % of the fluoride component, from about 0.001 weight % to about 30 weight % of the acid component, from about 0.1 weight % to about 1 weight % of the chelating agent, from about 0.1 weight % to about 1 weight % of the surfactant, and water (H₂O), based on a total weight of the cleaning agent.

16. A method of fabricating a semiconductor device comprising:
forming a dielectric layer on a semiconductor substrate;
forming a mask pattern on the semiconductor substrate forming exposed regions of the dielectric layer; and
etching the exposed regions of the dielectric layer using a microelectronic cleaning agent.

17. The method of claim 16, wherein the microelectronic cleaning agent comprises from about 0.001 weight % to about 10 weight % of a fluoride component, from about 0.001 weight % to about 30 weight % of an acid component, from 0.001 weight % to about 20 weight % of a chelating agent, from about 0.001 weight % to about 10 weight % of a surfactant, and water (H₂O), based on a total weight of the microelectronic cleaning agent.

18. The method according to claim 16, wherein the dielectric layer includes at least one high-k dielectric material selected from the group consisting of AlO, GdO, YbO, DyO, NbO, YO, HfO, HfSiO, HfAlO, HfSiON, ZrSiO, ZrAlO, ZrO, LaO, TaO, TiO, SrTiO, and BaSrTiO.

19. The method according to claim 16, wherein the mask pattern includes a gate electrode.

20. The method according to claim 16, wherein the mask pattern further includes a hard mask pattern laminated on the gate electrode.

21. The method according to claim 16, wherein the etching of the exposed regions of the dielectric layer is performed at a temperature from about 10° C. to about 80° C.

22. The method of claim 16, wherein the microelectronic cleaning agent comprises from about 0.1 weight % to about 1 weight % of a fluoride component, from about 0.001 weight % to about 30 weight % of an acid component, from about 0.1 weight % to about 1 weight % of a chelating agent, from about 0.1 weight % to about 1 weight % of a surfactant, and water (H₂O), based on a total weight of the cleaning agent.

23. The method of claim 17, wherein the water comprises a remainder of the microelectronic cleaning agent.

24. The method of claim 22, wherein the water comprises a remainder of the microelectronic cleaning agent.
